(19) United States
(12) Patent Application Publication
(10) Pub. No.: US 2006/0290253 A1
(43) Pub. Date: Dec. 28, 2006

(54) Enhanced Diffusing Plates, Films and Backlights

(75) Inventors: Terence E. Yeo, Boston, MA (US); Zane A. Coleman, Somerville, MA (US); Timothy L. Kelly, Boston, MA (US)

Correspondence Address: MINTZ, LEVIN, COHN, FERRIS, GLOVSKY;AND POPEO, P.C., ONE FINANCIAL CENTER, BOSTON, MA, 02111, US

(73) Assignee: Fusion Optix, Inc., Cambridge, MA (US)

(21) Appl. No.: 11/426,198

(22) Filed: Jun. 23, 2006

Related U.S. Application Data
(60) Provisional application No. 60/693,338, filed on Jun. 23, 2005.

(51) Int. Cl. H01J 5/16; H01K 1/30

(52) U.S. Cl. 313/116; 313/110

(57) ABSTRACT

The present invention provides improved light diffusing plates and films that can be used in backlights to increase brightness, provide more control over the viewing angle, reduce thickness and the reduce the overall display cost. By using a volumetric, asymmetric scattering region within a diffuser plate or film, light can be preferentially scattered more in one direction than the other direction. In backlights where the illumination light sources are substantially linear arrays, a diffuser plate or film that scatters predominantly in the direction perpendicular to the linear array will have more efficient forward light throughput than one that scatters light in a symmetric light scattering profile. In addition, a light re-directing region such as an asymmetric scattering region can efficiently allow a light-emitting device to be direct lit and edge lit, simultaneously.

### RELATED APPLICATION

This application claims the benefit of U.S. Provisional Application No. 60/693,338, filed Jun. 23, 2005, the entire teachings of which are incorporated herein by reference.

### BACKGROUND

Conventional LCD backlights for large displays have conventionally employed multiple lamps to provide sufficient brightness over a large area. Typically, these directly illuminated backlights are used for television and large display applications and contain linear arrays of fluorescent lamps with reflectors. In order to provide a uniform intensity profile from the surface of the backlight before passing through the LCD panel, volumetric diffuser plates or films are used to “spread-out” or diffuse the light from the linear array of fluorescent lights so as to eliminate the visibility of linear “hot spots” or non-uniformities in the backlight luminance.

These diffuser plates are typically 1 to 2 mm in thickness and contain substantially symmetric particles within the volume of the plate. The light from the fluorescent bulbs scatters substantially symmetrically, including light scattered backwards toward the lamps, within the diffuser plate (such that some light rays total internal reflect within the plate), and in the desired forward direction. Since the lamps are substantially linear in one direction (parallel to each other), and the diffusive elements in the backlight are illuminated with an asymmetric light intensity profile, the scattering of light parallel to the lamps is not necessary and can reduce the optical efficiency of the system.

For many display applications, such as for some televisions, the viewing angle in the vertical direction is reduced such that the brightness in the forward direction is increased. This light is typically directed from higher vertical angles closer to the normal to the display using collimating films, such as prismatic brightness enhancement films. This redirection is not 100% efficient because much of the light is totally internally reflected and directed back towards the lamps, where it could be absorbed or lost in the system. It is desirable for the light to be efficiently directed in the forward direction and only be diffused in directions where it is needed. A more efficient optical system for reducing the non-uniformities is needed to reduce the number of lamps (lower cost system) or reduced the brightness of the lamps (longer lifetime or lower cost lamps could be used).

In symmetrically scattering diffuser plates, the concentration of the particles determines the amount of scattering. A high concentration of particles will produce a larger percentage of light scattered back towards the light source (backscatter) and result in a lower backlight luminance in the forward direction normal to the display because a significant amount of the light directed backwards is absorbed. The concentration of particles is typically chosen by determining the minimum concentration required to produce a uniform backlight. However, because this non-uniformity is mostly in the direction perpendicular to the light sources, the increase in concentration to reduce the non-uniformity in the direction perpendicular to the light sources produces unwanted scattering (backward and forward) in the direction parallel to the light sources. This undesirable scattering reduces the backlight luminance or requires brighter or more light sources to achieve the desired brightness. A more optically efficient method for reducing the non-uniformity of the backlight is need to enable lower power fluorescent bulbs or reduced number of sources to be used and enable cost or power savings.

The light scattering particles typically used are substantially spherical in shape and the cost associated with obtaining these particles is significant. Also, the particles are used throughout the volume of the material, requiring large amounts of material to be specially manufactured. A lower cost method for obtaining the diffusion needed for a uniform backlight is desired.

The diffuser plates typically used in backlit light-emitting devices are typically 2 mm or more in thickness. One reason for this thickness is to provide sufficient support for the liquid crystal panel or other glass or objects in front of the backlight.

Similar to display applications, rear-illuminated signs, light fixtures and other light-emitting devices suffer from the inefficient scattering through the use of symmetric diffusers and diffuser plates.

Also, traditional backlights can suffer from poor color gamut, low brightness and inability to operate in certain advanced operating modes such as field-sequential color, which could alleviate the need for the color filters in the liquid crystal panel which absorb approximately 30% of the light from the backlight. The phosphors typically used in fluorescent lamps based backlights have a compromised color gamut in order to increase the luminance. As a result, backlights incorporating these lamps typically have a color gamut between 70% and 80% that of the NTSC standard color gamut. LED based backlights can improve the color gamut, although these typically have been limited in luminance due to the poor electrical efficiency and the need for a large number of high-brightness, high-cost LED's. A new device is needed that can provide increased color gamut and increased brightness while being cost efficient.

### SUMMARY

Disclosed herein are improved diffuser plates and films that can provide increased optical efficiency when used in a backlight, such as for an electronic display, and, more specifically, in an LCD backlight. These improved diffuser plates and the light-emitting devices can also be used in signs, light fixture applications and other light-emitting devices. By using one or more asymmetrically scattering regions in a diffuser plate or film, more control over the scattering of light can be obtained; and the optical efficiency can be increased. Additionally, by combining direct illumination with edge illumination through the use of a light re-directing region, the backlight will have increased luminance and color gamut at a reasonable cost.

In one embodiment, a diffuser plate or film contains substantially asymmetric particles aligned substantially along one axis such that incident light is preferentially scattering orthogonal to the aligned axis. In particular embodiments, the diffuser plate or film includes one or more anisotropic light-scattering regions containing asymmetric particles that may vary between 1 and 100 microns in size in the smaller dimension. The light scattering regions may be substantially orthogonal or parallel in their axis of alignment.

In another embodiment, the diffuser plate or film includes a substantially clear region and an asymmetrically scattering region containing substantially aligned asymmetric particles. In another embodiment, the amount of scattering is spatially varying in the plane of the diffusing plate or film. In additional embodiments, the diffuser plate or film contains light collimating features such as prismatic regions or refractive lenses.

In another embodiment of this invention, the improved diffuser plate or film is used in a display or other backlight application to improve performance. This performance improvement can be characterized by improved optical efficiency, brightness, light distribution, or other improved optical, physical, thermal, mechanical or environmental properties. The increased optically efficient backlight can translate to a brighter, more efficient, or lower cost display. In an additional embodiment of this invention, light collimating properties are incorporated into the improved diffuser plate, thus reducing the number of components required.

The diffuser plate or film can be used in combination with components, layers, or features including diffusers, collimating films, light sources, reflectors, reflective polarizers, and other known elements of a backlight to produce an efficient, uniform backlight system and display. The diffuser plate or film may be manufactured by extrusion or casting techniques and may be embossed, stamped, or compression molded in a suitable diffuser plate or film material containing asymmetric particles substantially aligned in one direction. The diffuser plate or film may be used with one or more light sources, collimating films or symmetric or asymmetric scattering films to produce an efficient backlight that can be combined with a liquid crystal display or other transmissive display. The diffuser plate or film and backlight using the same may be used to illuminate a display including electronic displays such as LCD's.

### BRIEF DESCRIPTION OF THE DRAWINGS

In the accompanying drawings, like reference characters refer to the same or similar parts throughout the different views. The drawings are not necessarily to scale, emphasis instead being placed upon illustrating particular principles, discussed below.

FIG. 1 is perspective view of a traditional liquid crystal display backlight.

FIG. 2 is a perspective view of one embodiment of an enhanced LCD backlight using an enhanced diffuser plate containing asymmetric particles aligned parallel to a linear array of fluorescent bulbs.

FIG. 3 is a perspective view of one embodiment of an enhanced LCD backlight using an enhanced diffuser plate containing asymmetric particles aligned parallel to a linear array of LED's.

FIG. 4 is a perspective view of one embodiment of an enhanced diffuser plate containing a layer with asymmetric particles optically coupled to a substrate.

FIG. 5 is a perspective view of one embodiment of an enhanced diffuser plate containing a layer with asymmetric particles beneath a rigid substrate with an air gap between them.

FIG. 6 is a perspective view of one embodiment of an enhanced diffuser plate containing a layer with asymmetric particles optically coupled to a substrate and a capping layer.

FIG. 7 is a perspective view of one embodiment of an enhanced diffuser plate containing a layer with asymmetric particles optically coupled to a substrate and a capping layer with refractive lenses on the opposite surface of the capping layer.

FIG. 8 is a perspective view of one embodiment of an enhanced diffuser plate containing two layers with asymmetric particles optically coupled to opposite faces of a substrate.

FIG. 9 is a perspective view of one embodiment of an enhanced diffuser plate containing a layer with asymmetric particles optically coupled to a substrate with a coating layer containing refractive lenses on the opposite surface of substrate.

FIG. 10 is a perspective view of one embodiment of an enhanced diffuser plate containing a layer with asymmetric particles optically coupled to a substrate with prismatic structures in a region optically coupled to the opposite surface of the substrate.

FIG. 11 is a perspective view of one embodiment of an enhanced diffuser plate containing a layer with asymmetric particles optically coupled to a substrate wherein prismatic surface structures are formed on the surface of the light scattering region.

FIG. 12 is a perspective view of one embodiment of an enhanced LCD backlight using an enhanced diffuser plate with two layers containing asymmetric particles aligned perpendicular to each other and a grid array of LED's.

FIG. 13 is a perspective view of one embodiment of an enhanced diffuser plate with a layer containing asymmetric particles located between a hard coating and a substrate.

FIG. 14 is a perspective view of one embodiment of an enhanced diffuser plate containing an asymmetrically diffusing layer and a substrate layer with hard coatings on both sides of the diffuser plate.

FIG. 15 is a perspective view of one embodiment of an enhanced diffuser plate with a layer containing asymmetric particles located between an anti-static coating and a substrate.

FIG. 16 is a perspective view of one embodiment of an enhanced diffuser plate containing an asymmetrically diffusing layer and a substrate layer with an antic-static coating on both sides of the diffuser plate.

FIG. 17 is a perspective view of one embodiment of an enhanced LCD backlight using an enhanced diffuser plate with a layer containing asymmetric particles, a substrate layer and a layer containing collimating features used with fluorescent bulbs.

FIG. 18 is a perspective view of one embodiment of an enhanced LCD backlight using an enhanced diffuser plate with collimating features that contain asymmetric particles and a substrate layer used with fluorescent bulbs and a reflective polarizer.

FIG. 19 is a perspective view of one embodiment of an enhanced LCD backlight using an enhanced diffuser plate containing a spatially varying concentration of asymmetric particles aligned parallel to a linear array of fluorescent bulbs.

FIG. 20 is a perspective view of one embodiment of an enhanced LCD backlight using an enhanced diffuser plate that is being illuminated from below by direct-lit fluorescent lamps and from the side by edge-lit LED's.

FIG. 21 is a perspective view of one embodiment of an enhanced LCD backlight using an enhanced diffuser plate that is being illuminated from below by direct-lit fluorescent lamps and from the side by edge-lit LED's.

### DETAILED DESCRIPTION

The features and other details of the invention will now be more particularly described. It will be understood that particular embodiments described herein are shown by way of illustration and not as limitations of the invention. The illustrations are not drawn to scale in order to illustrate particular features and properties. The principal features of this invention can be employed in various embodiments without departing from the scope of the invention. All parts and percentages are by weight unless otherwise specified.

Definitions

For convenience, certain terms used in the specification and examples are collected here.

“Diffuse” and “diffusing,” as defined herein, include light scattering or diffusion by reflection, refraction or diffraction from particles, surfaces, or layers or regions.

“Diffuser Plate” and “Diffuser Film” and “Diffuser” are referred to herein as optical elements that provide a scattering or diffusion property to one or more light rays. The change in angle of a light ray may be due to refraction, reflection, diffusion, diffraction or other properties known to change the direction incident light. Diffuser plates and films may be thick or thin and diffuser plates referred to herein may also refer to diffuser films or sheets and the optical functions may be similar. As suggested here, a diffuser plate (or film) may be thin and may incorporate many layers or regions providing different properties. A diffuser plate may incorporate other features or materials in the volume or on one or more surfaces that impart a desired optical, thermal, mechanical, electrical, or environmental performance.

“Polarizer,” as defined herein, includes absorbing or reflecting polarizers. These include dye and iodine based polarizers and reflective polarizers, such as DBEF from 3M. Linear or circular polarizers are also included. As used in these embodiments, it is commonly known that polarizers may be combined with waveplates or birefringent films in order to increase light recycling efficiency. For example, a quarter-wave film may be combined with a reflective polarizer to rotate the polarization state of the light such that more may pass through the polarizer when it is reflected back toward the polarizer.

“Optically coupled” is defined herein as a condition wherein two regions or layers are coupled such that the intensity of light passing from one region to the other is not substantially reduced by Fresnel interfacial reflection losses due to differences in refractive indices between the regions. “Optically coupling” methods include methods of coupling wherein the two regions coupled together have similar refractive indices or using an optical adhesive with a refractive index substantially near or in-between the regions or layers. Examples of “Optically coupling” include lamination using an index-matched optical adhesive, coating a region or layer onto another region or layer, or hot lamination using applied pressure to join two or more layers or regions that have substantially close refractive indices. Thermal transferring is another method that can be used to optically couple two regions of material. In manufacturing, two components may be combined during the forming process such as extrusion, coating, casting or molding. For example, two layers may be co-extruded together such that they are bonded or cured in contact with each other. In these instances, the layers or regions are referred to as optically coupled herein.

“Prismatic” or “Prismatic sheet” or “Prismatic structure” is defined herein as a surface relief structure that refracts or reflects light toward a desired direction. This refraction and reflection can provide collimating properties to light passing through the film. The structure can include arrays of elongated prism structures, micro-lens structures, and other surface relief structures. These features can be defined by a cross-sectional profile, a surface roughness, or by other surface characterization means.

“Collimating Film” and “Collimating structures” are defined here as films or structures wherein more of the light rays exiting the film or structures are directed toward the surface normal of the film or substrate plane in the case of structures on a substrate. Collimation properties can be achieved by refractive structures such as prisms, cones, microlenses, pyramids, hemispherical structures or linear, circular, random, regular, semi-random, or planar arrays of the aforementioned structures.

Used herein, “particles” and “domains” refer to individual regions of one or more materials that are distinctly different than their surroundings. They include organic particles, inorganic particles, dispersed phase domains, dispersed particles. They are lot limited in shape and may be fibrous, spherical, ellipsoidal, or plate-like in shape.

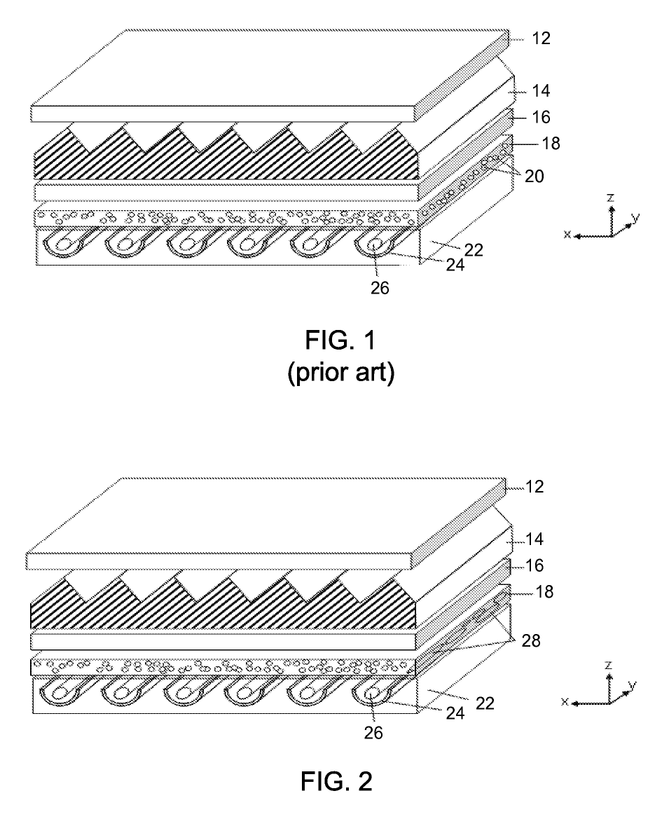

FIG. 1 shows the prior art of a backlight used for illuminating an LCD in a television application. Light from the linear array of fluorescent bulbs 26 and reflectors 24 aligned in the y direction is directed toward a diffuser plate 18. The diffuser plate 18 contains substantially symmetric particles 20 within the volume of the plate 18. The uniformity of the backlight luminance is increased due to the scattering of the light by the spherical particles. This diffuse light then passes through a collimating film 16 that is often referred to as a diffuser film because it has diffusive properties. Typically, this is a coating containing particles on a substrate. The particles protrude from the surface coating and create a microlens structure from the hemispherical protrusions. This film 16 has a diffusing effect as well as a collimating effect. The light then passes through a prismatic collimating film 14 such as BEF II from 3M where more light is directed from the larger angles in the x-z plane toward the direction normal to the display (+z axis). This light then passes through a reflective polarizer 12 such as DBEF from 3M where the light in the polarization orientation that would be absorbed by the bottom polarizer of the display is reflected from the reflective polarizer 12 to be recycled in the backlight.

By using symmetric particles 20 in the diffuser plate 18, light is scattering in undesirable directions (such as in the y and −z directions) and as a result, more of the light is absorbed. The absorption occurs because the diffuser plate 18 and other elements in the system including the case 22, bulbs 26, and reflectors 24 absorb a portion of the incident light. Therefore, it is desirable to minimize the light reaching these surfaces and for the light rays to reflect off of the surfaces a minimum number of times needed to achieve luminance uniformity and the desired angular light profile from the backlight. The luminance non-uniformity in the regions of the diffuser plate 18 is in the direction perpendicular to the linear light sources (x direction). As shown in FIG. 1, the light passing through the symmetrical diffuser plate 18 is scattered in the x, y, and z directions. While this does reduce the non-uniformity in the x direction, the symmetric diffuser plate 18 is optically inefficient and the spherical particles add a substantial cost to the diffuser plate 18.

FIG. 2 illustrates one embodiment of a backlight for a display wherein a diffuser plate 18 asymmetrically scatters light from a linear array of fluorescent bulbs 26 (aligned in the y direction) in a direction perpendicular to the array (x direction). This asymmetric scattering is due to the substantially aligned asymmetrically shaped particles aligned in the y direction. As a result, the luminance uniformity of the backlight is improved without the significantly scattering the light from the bulbs 26 in unneeded directions. A reflective polarizer 12 can be used to increase recycling efficiency, although for reduced costs, it may be omitted. In another configuration of this invention, the reflective polarizer 12 is diffusive or contains a diffusing layer, region or surface profile. In another configuration of this invention, the shape or concentration of the asymmetric particles in one or more the light scattering regions varies spatially.

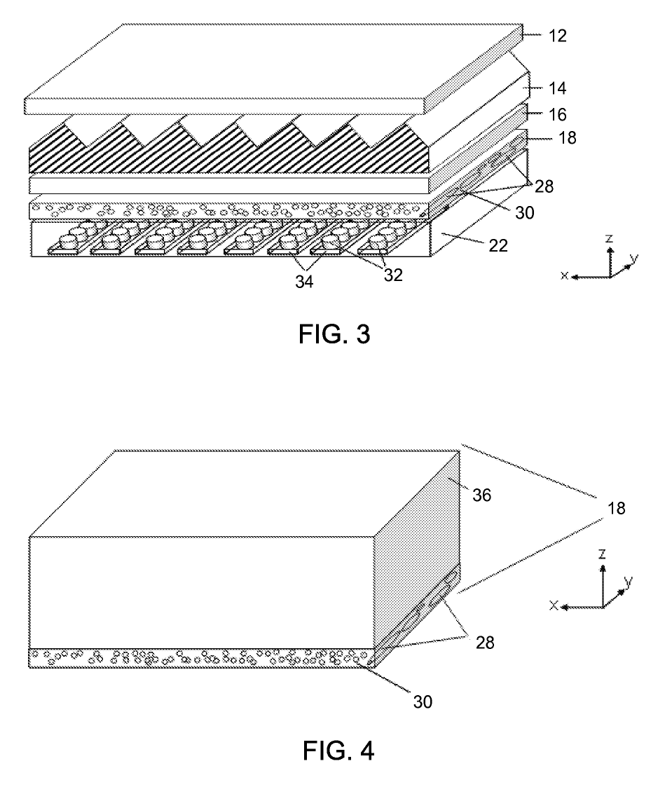

FIG. 3 illustrates another embodiment of a backlight for a display, wherein the light source used for the backlight is a linear array 34 of LED's 32. LED's are preferred in some backlights due to their longer lifetime and the larger potential color gamut. The array may be linear, in a grid, or other arrangement and may be a collection of red, green and blue LED's or white LED's or some combination thereof. In another configuration of this invention, the shape or concentration of the asymmetric particles in one or more the light scattering regions varies spatially.

FIG. 4 illustrates an embodiment of a diffuser plate 18 consisting of a layer 30 containing asymmetric particles 28 optically coupled to a substrate. Typically, one function of the diffuser plate 18 is to provide support and limit warping or distortion of the other optical films in the backlight system and the display. A thin diffusing layer 30 can be used with a rigid substrate to provide the necessary asymmetric diffusion while providing support for the other components of the system. As shown in FIG. 4, the diffusing layer 30 is located beneath the substrate (closer to the light sources in the backlight system arrangement); however in another embodiment, the diffusing layer 30 may be on the top of the backlight system (closer to the display). By using a thin layer containing asymmetric particles 28 as the diffusing region 30, the production of the specialized component (asymmetric diffusing layer) can be reduced in cost and produced more quickly. Additionally, a cost savings can be achieved by allowing more freedom to use different substrate materials for the rigid support to which the diffusing layer 30 is optically coupled.

Typical diffuser plates are made from PMMA, which has a flexural modulus of 3 GPa. In order to reduce the thickness of the diffuser plate, the diffuser plate must have a higher effective flexural modulus. In one embodiment of this invention, the dispersed phase domains may also be a material with a significantly higher flexural modulus, such that they increase the effective flexural modulus of the diffuser plate. By using a PET material with a 20% concentration of dispersed domains of glass fibers, the flexural modulus can be greater than 4 GPa. In one embodiment, the refractive index difference between the dispersed phase domains and the matrix material provide anisotropic diffusion while also providing increased effective flexural modulus. In another embodiment, the diffuser plate contains more than one region of dispersed domains wherein the first region isotropically or anisotropically scatters incident light and the refractive index of the second dispersed phase domains substantially equals the refractive index of the matrix and are made of a material with a higher flexural modulus that substantially increases the effective flexural modulus.

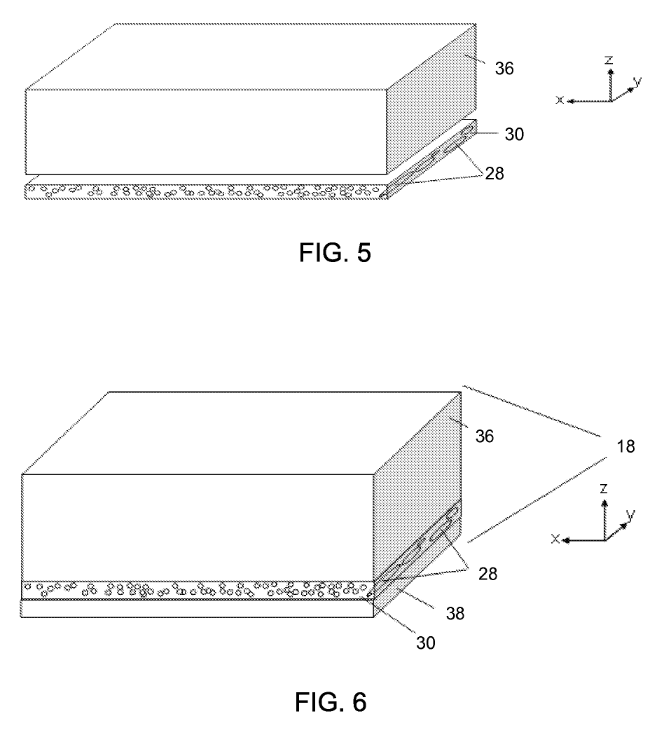

The diffuser plate shown in FIG. 5 is similar to that shown in FIG. 4 except that the asymmetric diffusing region 30 is not optically coupled to the substrate. The diffuser 30 may be sufficiently rigid to prevent warpage from light, heat, and humidity situations, and the substrate may provide additional rigidity to support additional components in the system. In another embodiment, the diffuser is located above the rigid substrate and is not optically coupled to the substrate. The diffuser 30, substrate, or both may have surface relief features to prevent wet-out and/or to provide collimation. In another configuration of this invention, the shape or concentration of the asymmetric particles in one or more the light-scattering regions varies spatially.

FIG. 6 illustrates another embodiment of a diffuser plate 18 containing an asymmetrically diffusing layer 30 between two substantially non-diffusing layers. In the example shown in FIG. 6, the top layer is a substrate of a substantially transparent polymer. The layer beneath the light diffusing layer 30 is a capping layer 38 on the diffuser film that can serve one or more functions. The capping layer 38 may contain light absorbing materials to enhance the light stability of the diffuser plate 18. The capping layer 38 may also contain anti-static components, hardcoats, anti-blocking features, or other components known to provide optical, thermal, environmental, electrical, physical or other benefits to films and diffuser plates. The layer 38 between the light diffusing layer 30 and the light source may also serve to protect the light diffusing region 30 from support posts in the backlight casing or it may provide planarization to the surface of the light diffusing layer 30 to produce a more planar surface for better adhesion and coverage of additional layers or coatings. In another configuration of this invention, the shape or concentration of the asymmetric particles in one or more the light scattering regions varies spatially.

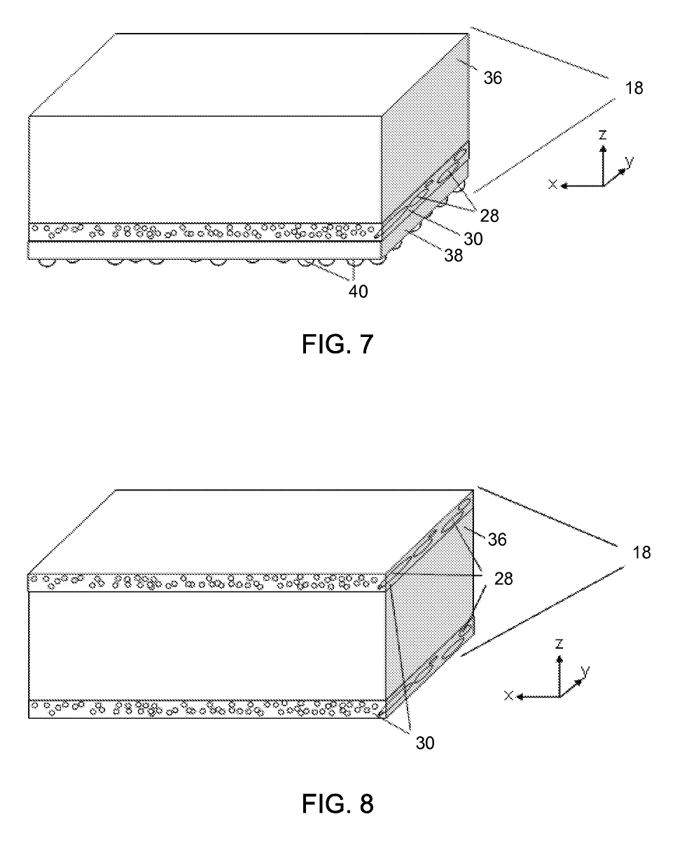

FIG. 7 illustrates an embodiment of a diffuser plate 18 containing a substrate, asymmetrically diffusing layer 30, capping layer 38 and a region of refractive lenses 40. The refractive lenses 40 can be made from a coating containing spherical particles that is optically coupled to the diffusing layer 30. By adjusting the particle concentration and size along with the coating thickness, the particles can form protruding hemispherical lenses. These lenses can capture and redirect light into the diffusive layer 30 that might ordinarily be reflected from steep angles. The lenses may be designed to provide collimation of the light. In another embodiment of this invention, other collimation features may be used on the bottom surface to direct light into the diffuser plate 18. Examples of suitable features include a linear array of prisms or pyramids. In another configuration of this invention, the shape or concentration of the asymmetric particles in one or more the light scattering regions varies spatially.

FIG. 8 illustrates another embodiment of this invention, wherein more than one diffusive region 30 is contained within the diffuser plate 18. In the example shown, a substantially non-scattering region (substrate) is located between two thinner asymmetrically scattering layers. In this configuration, the light from the lamps that reaches the first diffuser 30 is preferentially scattered in the x-z plane. As this light travels the distance through the clear substrate, the intensity of the light distribution is spread in the x-direction thus making the intensity profile more uniform in the x-direction. The second diffusing layer 30 provides a secondary diffusing surface upon which the light diffusing effects of the first diffusing layer 30 can be additionally modified. The second diffusing region 30 can further diffuse the light in the x-z plane, resulting in a more uniform backlight and display luminance. More than two diffusing layers 30 may be used and the diffusing planes may be orthogonal to each other. One or more of the regions 30 may be substantially symmetrically scattering, and symmetrically scattering particles may be located in regions 30 containing substantially asymmetric particles 28. The thicknesses of one or more of the diffusing or non-diffusing layers may be substantially thinner than another layer. In another configuration of this invention, the shape or concentration of the asymmetric particles in one or more the light scattering regions varies spatially.

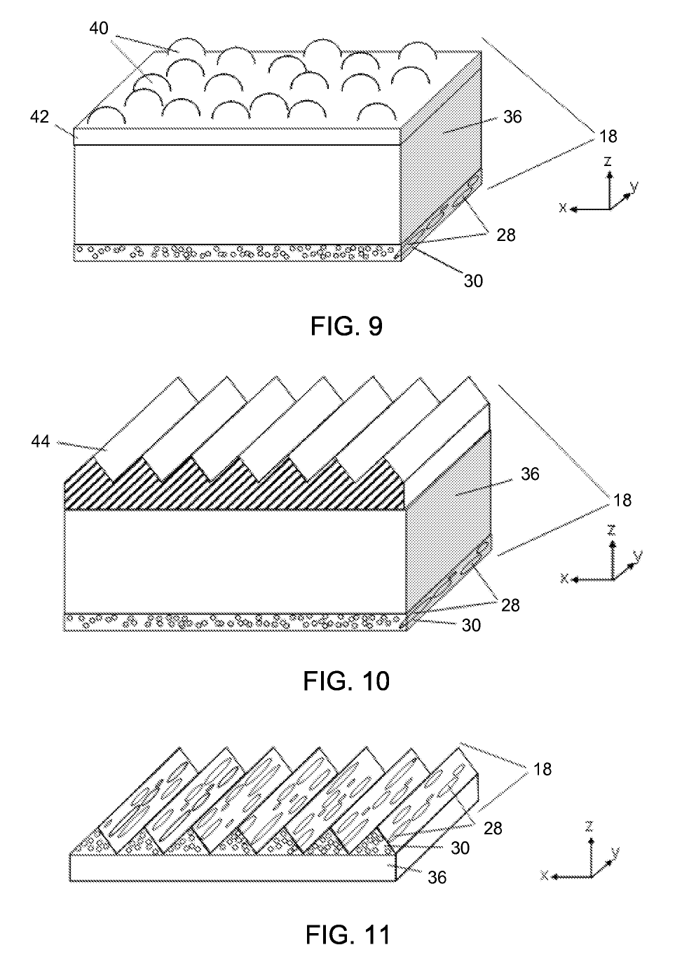

FIG. 9 illustrates another embodiment of a diffuser plate 18 containing an asymmetrically scattering layer 30 and a collimating layer 42. In the example shown in FIG. 9, a clear substrate is between a layer containing asymmetric particles 28 and a coating layer 42 that contains substantially spherical particles. By using a collimating layer 42 on the top surface of the diffuser plate 18, the light from the scattering layer can become more collimated due to refraction properties of the lenses 40. The collimating layer 42 may be a coating containing protruding particles. By adjusting the particle concentration and size along with the coating thickness, the particles can form protruding hemispherical lenses 40. The coating continuous phase or the dispersed particles may be made of a composition that provides increased benefits such as anti-blocking, anti-static properties, hardcoat, reduced or increased scratch resistance needed to be compatible with the hardness of the next layer in the backlight system, light resistance, increased thermal expansion or other properties known to improve the performance of an optical film or diffuser plate 18 in an LCD backlight. By optically coupling a light collimating layer to the diffuser plate 18, an additional film that is often used in a backlight can be eliminated and the potential for dust and scratches is reduced because the number of exposed surfaces is reduced. In another configuration of this invention, the shape or concentration of the asymmetric particles in one or more the light scattering regions varies spatially.

FIG. 10 illustrates a another embodiment of this invention of a diffuser plate 18 containing an asymmetric light scattering layer, a substrate, and a collimating layer consisting of a substantially linear array of prismatic structures 44. It is known in the industry that prismatic arrays 44 can increase the luminance of the backlight and display in the direction normal to the display. The prismatic array 44 is optically coupled to the substrate and the light scattering layer is optically coupled to the opposite surface of the substrate. The array of prisms 44 may be parallel or perpendicular to the preferential light scattering direction of the diffusing layer 30. As shown, the light from light scattering region is scattered more in the x-z plane than in the y-z plane. The prismatic structures 44 help to re-collimated the light in the x-z plane after the luminance uniformity is improved by the asymmetric light scattering layer. In another configuration of this invention, the linear array of prisms 44 is aligned parallel to the x-z plane such that the prisms improve the collimation of the light in the y-z plane. In another configuration of this invention, the shape or concentration of the asymmetric particles in one or more the light scattering regions varies spatially. FIG. 11 illustrates another embodiment of this invention, wherein the light collimating features and light scattering particles are located within the same layer 30. As illustrated, the asymmetric particles 28 are aligned parallel to the linear array of prisms 44 that collimate the light. By combining one or more of the light scattering regions with the collimating features (surface relief structures, prismatic, microlens, pyramidal, or other refractive surface structure), a thinner diffuser plate 18 can be realized. In another embodiment of this invention, the linear array of prismatic features 44 is aligned perpendicular to the alignment of the asymmetric particles 28. The surface relief features may be embossed, cast or otherwise formed in the light scattering region 30 during the manufacturing process. In another configuration of this invention, an additional light diffusing layer is optically coupled to the opposite side of the substrate to increase the amount of diffusion and increase luminance uniformity. In another configuration of this invention, the shape or concentration of the asymmetric particles in one or more the light scattering regions varies spatially.

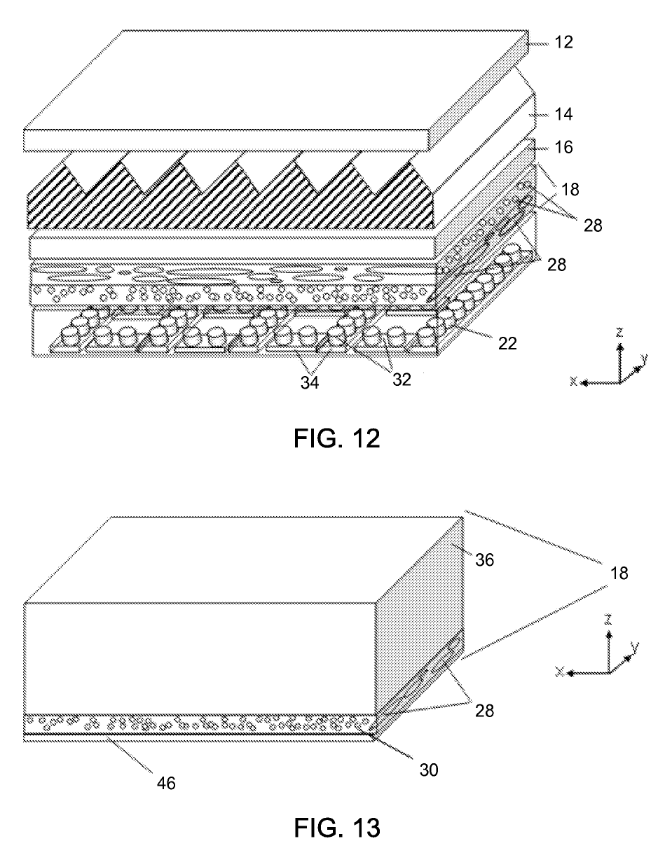

FIG. 12 illustrates another embodiment of a diffuser plate 18 containing two diffusing layers that have their stronger diffusing axis perpendicular to each other. If the rigidity of the combined layers is sufficient, the substrate may not be needed. In another embodiment, a substrate is used to support the light diffusing layers. The diffusing layers may both be on top of the substrate, bottom of the substrate or on opposite sides of the substrate. When a grid array of light sources is used in a backlight, the intensity needs to be more uniform in the x and y directions. By using two crossed asymmetric layers aligned in the x and y directions, the light is diffused substantially more in the x and y directions without significant diffusion in the direction at 45 degrees to the x and y axis, for example. Since light does not need to be scattered along this direction in order to achieve luminance uniformity, the backlight is more optically efficient than one using a symmetrically scattering diffuser plate. Beneath the light diffusing layers is a light case 22 including LED's 32 and optics arranged in arrays 34. In another configuration of this invention, the shape or concentration of the asymmetric particles in one or more the light scattering regions varies spatially.

FIG. 13 illustrates another embodiment of a diffuser plate 18 containing a light scattering layer between a substrate 36 and a hard coating layer 46. A hard coating layer 46 can be applied to the diffuser plate 18 to increase the pencil hardness, to protect the film from damage to other components, or to protect other components from damaging the asymmetric layer or combinations thereof. The coating 46 may be chosen to increase or decrease the surface hardness or scratch resistance. The coating 46 may contain other additives or features to provide anti-static, light collimating properties, anti-blocking, UV or light absorption properties, anti-wetting or other properties such as are known in the optical films and backlight industries. In another configuration of this invention, the shape or concentration of the asymmetric particles in one or more the light scattering regions varies spatially.

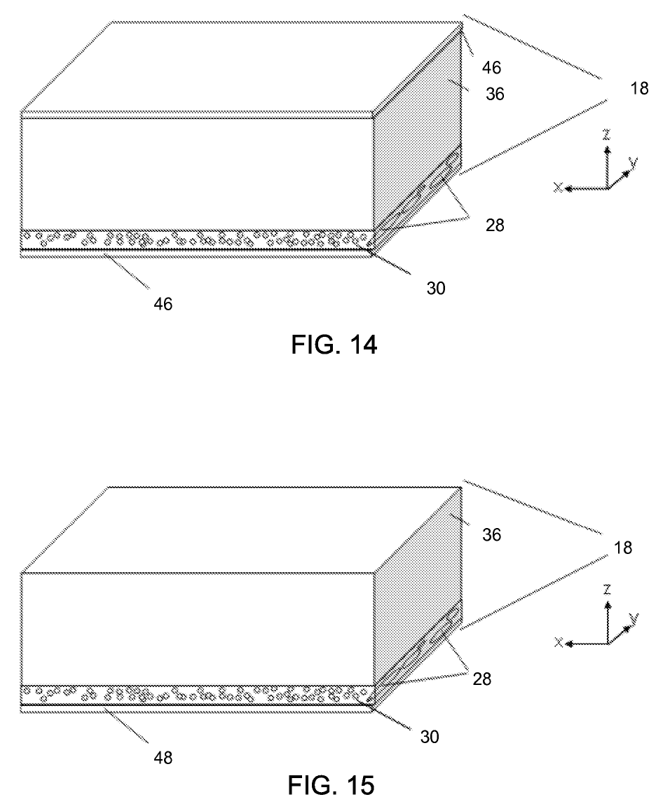

FIG. 14 illustrates another embodiment of this invention of a diffuser plate 18 containing a light scattering layer on a substrate 36 with hard coatings 46 on both outer surfaces. The hard coating layers 46 can be applied to the diffuser plate 18 to increase the pencil hardness, to protect the film from damage to other components, or to protect other components from damaging the asymmetric layer or combinations thereof. The coating 46 may be chosen to increase or decrease the surface hardness or scratch resistance. The coating 46 may contain other additives or features to provide anti-static, UV or light absorption properties, light collimating properties, anti-blocking, anti-wetting or other properties such as are known in the optical films and backlight industries. In another configuration of this invention, the shape or concentration of the asymmetric particles in one or more the light scattering regions varies spatially.

FIG. 15 illustrates another embodiment of a diffuser plate 18 containing a light scattering layer between a substrate 36 and an anti-static coating 48. In another embodiment, an anti-static region is added to the volume of the asymmetric diffusing material 28 or added as an additional layer during the manufacturing process (such as co-extrusion, capping layers, lamination, and other methods for joining regions or layers during manufacturing films, sheets and coatings). An anti-static coating 48 can be applied to the diffuser plate 18 to reduce dust collection and static buildup during production. The coating may contain other additives to provide desired scratch resistance or pencil hardness, anti-blocking, UV or light absorption properties, anti-wetting or other properties such as are known in the optical films and backlight industries. In another configuration of this invention, the shape or concentration of the asymmetric particles in one or more the light scattering regions varies spatially.

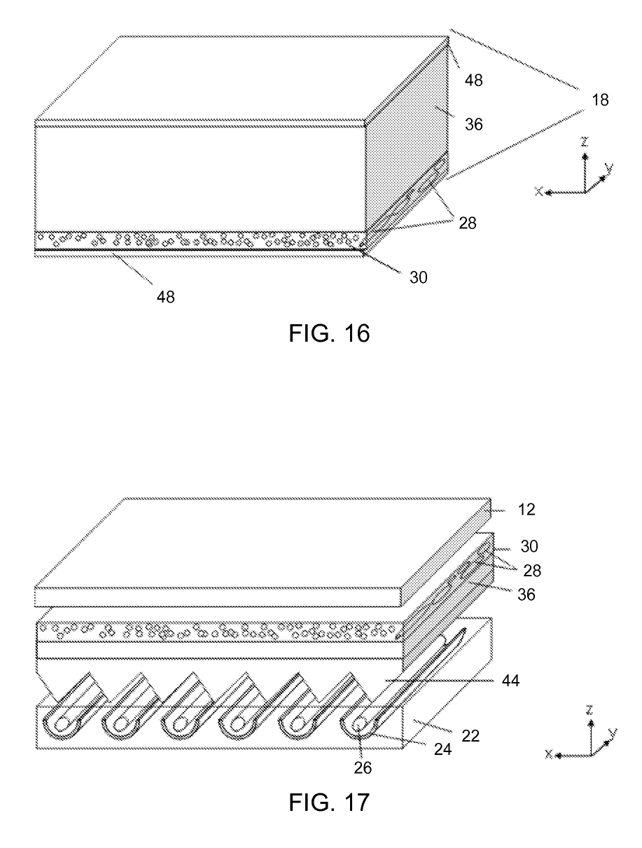

FIG. 16 illustrates another embodiment of a diffuser plate 18 containing a light scattering layer with anti-static coatings 48 on both sides. In another embodiment, an anti-static region is added to the volume of the diffusing layer 30 or substrate 36, or it is added as additional layers during the manufacturing process (such as co-extrusion, capping layers, lamination, and other methods for joining regions or layers during manufacturing films, sheets and coatings). An anti-static coating 48 can be applied to the diffuser plate 18 to reduce dust collection and static buildup during production. The coating 48 may contain other additives to provide desired scratch resistance or pencil hardness, anti-blocking, UV or light absorption properties, anti-wetting or other properties such as are known in the optical films and backlight industries. In another configuration of this invention, the shape or concentration of the asymmetric particles in one or more the light scattering regions varies spatially.

FIG. 17 illustrates one embodiment of a backlight for a display with a diffuser plate 18 containing collimating features (e.g., prismatic structure 44) that collimate the light in the direction perpendicular to the array of fluorescent bulbs 26. With the collimating features on the light source side of the diffuser plate 18, the light can be collimated and re-directed before reaching the asymmetric diffuser region. This can provide improved light uniformity with a potential for reduced thickness. Since the prismatic features are on the light source side, the potential for other films to scratch the prisms is reduced. In the illustration, the prisms are aligned parallel to the fluorescent bulbs 26 and the asymmetric particles 28. The relative orientation of the bulbs 26, the prisms (or other collimating feature), and the axis of the asymmetric particles 28 may be perpendicular, parallel or at an angle gamma with respect to each other. For example, the linear array of prisms may be aligned in the x direction (orthogonal to the array of fluorescent bulbs 26 that are aligned in the y direction) and the asymmetric particles 28 may be aligned in the y direction. In a preferred embodiment, the linear array of prisms is aligned in the y direction (parallel to the array of fluorescent bulbs 26 that are aligned in the y direction), and the asymmetric particles 28 are aligned in the y direction. In another configuration of this invention, the shape or concentration of the asymmetric particles in one or more the light scattering regions varies spatially.

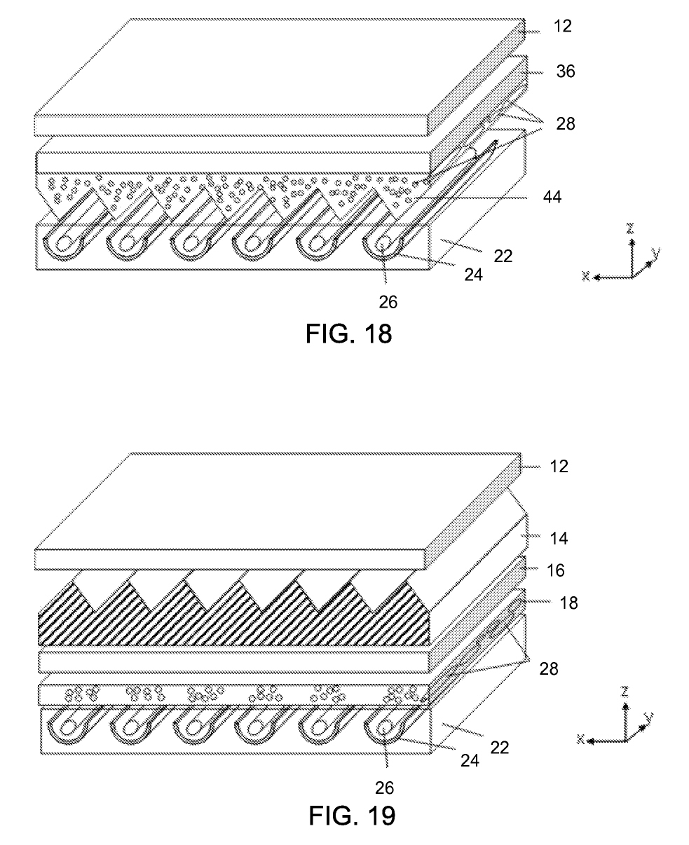

FIG. 18 illustrates one embodiment of a backlight for a display with a diffuser plate containing collimating features that collimate the light in the direction perpendicular to the array of fluorescent bulbs 26. With the collimating features on the light source side of the diffuser pate, the light can be collimated and re-directed before reaching the asymmetric diffuser region. The collimating features are located on the surface of the asymmetric light scattering layer. As a result, the final thickness can be reduced and the number of individual layers, coatings, laminations, etc. can be reduced, thus enabling simpler manufacturing techniques and less chance of dust contamination or scratches. The light collimating features and the asymmetric diffuser can provide improved light uniformity with a potential for reduced thickness. Since the prismatic features are on the light source side, the potential for other films to scratch the prisms is reduced. In the illustration, the prisms are aligned parallel to the fluorescent bulbs 26 and the asymmetric particles 28. The relative orientation of the bulbs 26, the prisms (or other collimating feature), and the axis of the asymmetric particles 28 may be perpendicular, parallel or at an angle gamma with respect to each other. For example, the linear array of prisms may be aligned in the x direction (orthogonal to the array of fluorescent bulbs 26 that are aligned in the y direction), and the asymmetric particles 28 may be aligned in the y direction. In a preferred embodiment, the linear array of prisms is aligned in the y direction (parallel to the array of fluorescent bulbs 26 that are aligned in the y direction), and the asymmetric particles 28 are aligned in the y direction. In another configuration of this invention, the shape or concentration of the asymmetric particles in one or more the light scattering regions varies spatially.

FIG. 19 illustrates another embodiment of this invention of an enhanced backlight using an enhanced diffuser plate 18 with spatially varying diffusion properties. The diffusion plate 18 contains multiple regions with varying concentrations of asymmetric particles 28. The region directly above the light sources has a higher intensity and need more diffusion to improve the uniformity. The asymmetric particles 28 above that region will improve the optical efficiency and luminance uniformity of the backlight. In the regions further from the light sources, the lower concentration of particles allows for improved transmission (less backscatter). As a result, the optical efficiency is improved. In another configuration of this invention, the shape or concentration of the asymmetric particles in one or more the light scattering regions varies spatially.

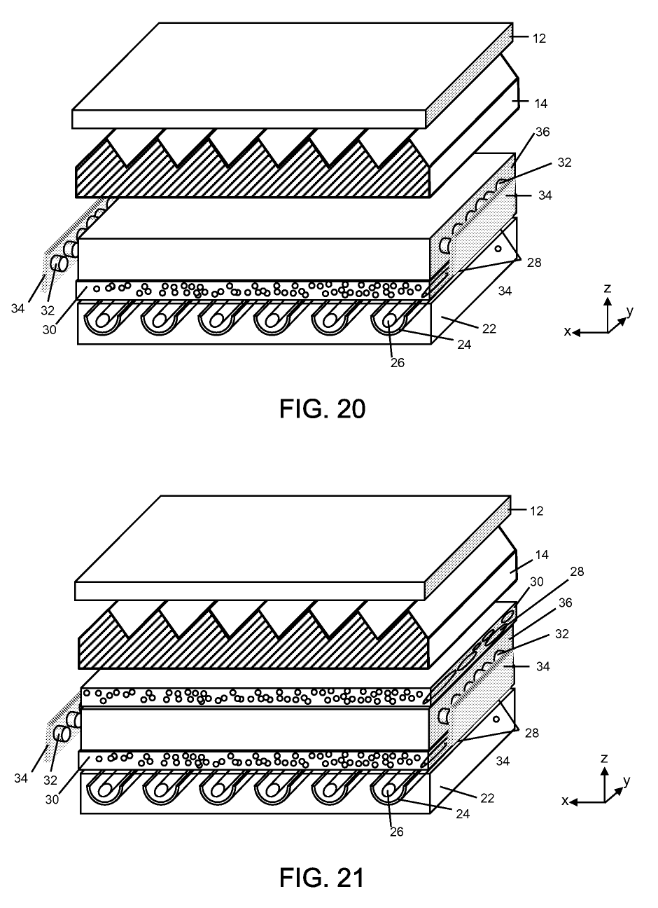

FIG. 20 illustrates another embodiment of an enhanced backlight using an enhanced diffuser plate that is capable of being simultaneously illuminated from the edge or directly from behind, incorporating a light re-directing region. In traditional edge-lit LCD's, the light that is waveguided through a substrate is coupled out of the substrate by the use of reflectively scattering white printed dots or patterns. When illuminated from underneath, these reflect white scattering dots do not transmit the light in that region and would thus appear darker when viewed from the opposite side. By using light re-directing regions that transmit light as well as redirect light, the light from the sources that is waveguided will be redirected into angles smaller than the critical angle for total internal reflection and escape the transmissive region and the light from below will transmissively pass through and be redirected. By combining the direct-lit illumination with the edge-lit illumination, increased color gamut and brightness can be achieved by combining different types of light sources.

The transmissive light re-directing region may contain refractive structures, reflective structures, diffractive structures, scattering structures or some combination thereof. For example, as shown in FIG. 20, the light from the fluorescent bulb 26 and reflector 24 is scattered by the anisotropic light scattering region 30 such that the luminance uniformity in increased. The light from the LED's 32 in the LED array 34 is coupled through the edge of the light transmissive substrate such that a significant portion of the light is waveguiding. A portion of this light upon reaching the anisotropic light-scattering region is re-directed into angles that can escape the lightguide toward the output surface. The light from the LED's can further increase the luminance or increase the color gamut over the light from only the fluorescent sources. Additional brightness enhancing films such as prismatic film 14 and a reflective polarizer 12 may also be used to increase the luminance. White, red, green, blue or other color LED's or other light-emitting sources can be used as the direct-lit as well as the edge-lit sources.

The LED illumination also allows for the capability for enhanced display modes. For example, the fast switching rates of the LED's can allow for the display to be driven in color sequential or field sequential mode. A dynamic spatial color enhanced mode can also be generated by using more or less of one color of light from a colored light source. For example, the backlight could use the white luminance and color gamut from the fluorescent sources and in a scene being displayed where the red gamut that is needed is more than is provided from the fluorescent sources, the red LED's can be driven on accordingly. Additionally, the spatial location of the red LED's along the edge can be driven appropriately to provide the color in a more preferred spatial location (dynamic spatial color enhancement). For example, in a scene where blue sky is being displayed on the top half of the display, the blue LEDs along the top edges and/or the LED's along the side edges near the top can be turned on, giving a dynamic color enhancement effect. Similary, the red, green, and blue (or white) LED's can be driven on in a location to increase the total luminance in one region (spatial luminance enhancement mode), and they could not be driven on in a region that needed a lower luminance, thus enhancing the contrast (dynamic contrast enhancement).

In a preferred embodiment, the light directed from one or more sources is substantially collimated. In another preferred embodiment, the color gamut of a display incorporating this backlight is greater than 90% of the NTSC standard. In another embodiment, the dark room contrast ratio of the display is greater than 300:1. In another configuration of this invention, the shape or concentration of the asymmetric particles in one or more the light scattering regions varies spatially.

FIG. 20 illustrates another embodiment of an enhanced backlight using an enhanced diffuser plate that is capable of being simultaneously illuminated from the edge or directly from behind employing two transmissive light re-directing regions. By using two anisotropic light-scattering regions, the uniformity of the light-transmitting region can be increased. The light from the fluorescent bulb 26 and reflector 24 is scattered by the anisotropic light-scattering region 30. This creates a primary cross-sectional luminance profile that has a higher luminance in the region directly above the fluorescent bulb due to the closer proximity to the bulb, otherwise referred to as a “hot-spot.”

This luminance profile propagates through the non-scattering region of the light-transmissive region 36 and then becomes the input luminance profile for the second light-scattering region. The second light-scattering region creates a second light-scattering profile that has a lower intensity in the region directly above the fluorescent lamp and a higher intensity in the region between the fluorescent lamps, thus creating a more uniform luminance profile. Thus, by using two weaker anisotropic films (smaller full-width at half maximum cross sections when illuminated with collimated light) instead of one stronger anisotropic film, the intermediate luminance profile creates a re-distribution of the light that enables a second light-scattering region to further re-distribute the light such that the total luminance is more uniform along at least one direction.

Similarly, the light from the LED's 32 in the LED array 34 is coupled through the edge of the light-transmissive substrate, and this light is coupled out of the waveguide by one or more of the light-scattering regions. When using one-light scattering region that is highly scattering, the luminance profile can be brighter toward the edges if not carefully controlled. By using more than one light-scattering region, the higher luminance normally closer to the edge would be further spread along at least one axis by the second light-scattering region, thus making the luminance more uniform. In another configuration of this invention, the shape or concentration of the asymmetric particles in one or more the light scattering regions varies spatially.

Diffusing Regions

The diffuser plate or diffuser of this invention may contain more than one diffusing region or layers. One or more of the diffusing regions may have an asymmetric diffusion profile. The diffusion plate or backlight may contain volumetric and surface relief based diffusive regions that may be asymmetric or symmetric. The diffusing layers may be optically coupled or separated by another material or an air gap. In a preferred embodiment, a rigid, substantially transparent material separates two diffusing regions. In a preferred embodiment, the asymmetrically diffusive regions are aligned such that the luminance uniformity of a backlight is improved. In another preferred embodiment, the spatial luminance profile of a backlight using a linear or grid array of light sources is substantially uniform through the use of one or more asymmetrically diffusing regions.

The amount of diffusion in the x-z and y-z planes affects the luminance uniformity and the potential viewing angle of the backlight and display. By increasing the amount of diffusion in one plane preferentially over that in the other plane, the viewing angle is asymmetrically increased. For example, with more diffusion in the x-z plane than the y-z plane, the viewing angle of the display (related to the luminance and display contrast) can be increased in the x direction. The diffusion asymmetry introduced through one or more diffusing layers of a diffuser film 16 or diffuser plate 18 in a backlight can allow for greater control over the viewing angle and angular intensity profile of the display and the optical efficiency of the backlight and display system. In another embodiment, amount of diffusion (typically measured as FWHM of the angular intensity profile) varies in the plane of the diffusing layer. In another embodiment, the amount of diffusion varies in the plane perpendicular to the plane of the layer (z direction). In a preferred embodiment, the amount of diffusion is higher in the regions in close proximity of one or more of the light sources.

Alignment of Diffusing Axis in Diffuser Plate

The alignment of the axis of stronger diffusion in a diffuser or diffuser plate may be aligned parallel, perpendicular or at an angle theta with respect to a light source or edge of the backlight. In a preferred embodiment, the axis of stronger diffusion is aligned perpendicular to the length of a linear light source in a backlight.

Particle Shape

The particles within one or more diffuser layers may be fibrous, spheroidal, cylindrical, spherical, other non-symmetric shape, or a combination of one or more of these shapes. The shape of the particles may be engineered such that substantially more diffusion occurs in the x-z plane than that in the y-z plane. The shape of the particles or domains may vary spatially along one or more of the x, y, or z directions. The variation may be regular, semi-random, or random.

Particle Alignment

The particles within a diffusing layer may be aligned at an angle normal, parallel, or an angle theta with respect to an edge of the diffusing layer or a linear light source or array of light sources. In a preferred embodiment, the particles in a diffusing layer are substantially aligned along one axis that is parallel to a linear array of light sources.

Particle Location

The particles may be contained within the volume of a continuous phase material or they may be protruding from the surface or substantially planar surface of the continuous phase material.

Particle Concentration

The particles described herein in one or more light diffusing layers may be in a low or high concentration. When the diffusion layer is thick, a lower concentration of particles is needed. When the light diffusing layer is thin, a higher concentration of particles is needed. The concentration of the dispersed phase may be from less than 1% by weight to 50% by weight. In certain conditions, a concentration of particles higher than 50% may be achieved by careful selection of materials and manufacturing techniques. A higher concentration permits a thinner diffusive layer and as a result, a thinner backlight and display. The concentration may also vary spatially along one or more of the x, y, or z directions. The variation may be regular, semi-random, or random.

Index of Refraction

The refractive index difference between the particles and the matrix may be very small or large. If the refractive index difference is small, then a higher concentration of particles may be required to achieve sufficient diffusion in one or more directions. If the refractive index difference is large, then fewer particles (lower concentration) are typically required to achieve sufficient diffusion and luminance uniformity. The refractive index difference between the particles and the matrix may be zero or larger than zero in one or more of the x, y, or z directions.

The refractive index of the individual polymeric phases is one factor that contributes to the degree of light scattering by the film. Combinations of low and high refractive index materials result in larger diffusion angles. In cases where birefringent materials are used, the refractive indexes in the x, y, and z directions can each affect the amount of diffusion or reflection in the processed material. In some applications, one may use specific polymers for specific qualities such as thermal, mechanical, or low-cost, however, the refractive index difference between the materials (in the x, y, or z directions, or some combination thereof) may not be suitable to generate the desired amount of diffusion or other optical characteristic such as reflection. In these cases, it is known in the field to use small particles, typically less than 1 micron in size to increase or decrease the average bulk refractive index. Preferably, light does not directly scatter from these added particles, and the addition of these particles does not substantially increase the absorption or backscatter.

Additive particles can increase or decrease the average refractive index based on the amount of the particles and the refractive index of the polymer to which they are added, and the effective refractive index of the particle. Such additives can include: aerogels, sol-gel materials, silica, kaolin, alumina, fine particles of MgF₂ (its index of refraction is 1.38), SiO₂ (its index of refraction is 1.46), AlF₃ (its index of refraction is 1.33-1.39), CaF₂ (its index of refraction is 1.44), LiF (its index of refraction is 1.36-1.37), NaF (its index of refraction is 1.32-1.34) and ThF₄ (its index of refraction is 1.45-1.5) or the like can be considered, as discussed in U.S. Pat. No. 6,773,801. Alternatively, fine particles having a high index of refraction, may be used such as fine particles of titania (TiO₂) or zirconia (ZrO₂) or other metal oxides.

Surface Relief Structure

One or more surfaces of the diffusing layer or region of a diffuser plate may contain a non-planar surface. The surface profile may contain protrusions or pits that may range from 1 nm to 3 mm in the x, y, or z directions. The profile or individual features may have periodic, random, semi-random, or other uniform or non-uniform structure. The surface features may be designed to provide function to the diffuser plate such as collimation, anti-blocking, refraction, symmetric diffusion, asymmetric diffusion or diffraction. In a preferred embodiment, the surface features are a linear array of prismatic structures that provide collimation properties. In another preferred embodiment, the surface contains hemispherical protrusions that prevent wet-out, provide anti-blocking properties, or light collimating properties.

Collimation Properties

One or more surfaces of the diffusing layer or plate may contain surface profiles that provide collimation properties. The collimation properties direct light rays incident from large angles into angles closer to the display normal (smaller angles). The features may be in the form of a linear array of prisms, an array of pyramids, an array of cones, an array of hemispheres or other feature that is known to direct more light into the direction normal to the surface of the backlight. The array of features may be regular, irregular, random, ordered, semi-random or other arrangement where light is can be collimated through refraction, reflection, total internal reflection, diffraction, or scattering.

Additional Diffuser Plate Properties

The enhanced diffuser plate of this invention may contain materials, additives, components, blends, coatings, treatments, layers or regions that provide additional optical, mechanical, environmental, thermal or electrical benefits. The properties of the diffuser plate or film may include one or more of the following:
Optical: increased optical throughput, increased/decreased diffusion along one or more axis, reduced or increased birefringence, increased luminance uniformity, improved color stability, reduced haze.
Mechanical/Physical: increase rigidity, reduced thickness, reduced weight, increased scratch resistance, reduced/increased pencil hardness, anti-blocking features,
Environment: reduced warpage, increased light resistance, increased moisture resistance, increased light resistance, increased ultraviolet absorption,
Thermal: increased thermal resistance, increased softening temperature.
Electrical: decreased surface resistance

Other properties that are known in the industry to improve the performance of a diffuser plate or film may also be incorporated into one of these regions.

Diffuser Plate Composition

The diffuser plate may be composed of on or more light scattering regions containing a continuous phase and a dispersed phase. In another embodiment, the diffuser plate may contain a region of light scattering surface features that exhibit asymmetric scattering properties. In another embodiment, one or more of the diffusing layers may be an adhesive joining two or more components of the backlight system. The plate may also contain a substrate that may be substantially optically transparent and a continuous phase. The materials chosen for the substrate, dispersed, or continuous phases may be one or more polymeric or inorganic materials.

Such polymers include, but are not limited to acrylics, styrenics, olefins, polycarbonates, polyesters, cellulosics, and the like. Specific examples include poly(methyl methacrylate) and copolymers thereof, polystyrene and copolymers thereof, poly(styrene-co-acrylonitrile), polyethylene and copolymers thereof, polypropylene and copolymers thereof, poly(ethylene-propylene) copolymers, poly(vinyl acetate) and copolymers thereof, poly(vinyl alcohol) and copolymers thereof, bisphenol-A polycarbonate and copolymers thereof, poly(ethylene terephthalate) and copolymers thereof, poly(ethylene 2,6-naphthalenedicarboxylate) and copolymers thereof, polyarylates, polyamide copolymers, poly(vinyl chloride), cellulose acetate, cellulose acetate butyrate, cellulose acetate propionate, polyetherimide and copolymers thereof, polyethersulfone and copolymers thereof, polysulfone and copolymers thereof, and polysiloxanes.

Numerous methacrylate and acrylate resins are suitable for one or more phases of the present invention. The methacrylates include but are not limited to polymethacrylates such as poly(methyl methacrylate), poly(ethyl methacrylate), poly(propyl methacrylate), poly(butyl methacrylate), poly(isobutyl methacrylate), methyl methacrylate-methacrylic acid copolymer, methyl methacrylate-acrylate copolymers, and methyl methacrylate-styrene copolymers (e.g., MS resins). The preferred methacrylic resins include poly(alkyl methacrylate)s and copolymers thereof. The most preferred methacrylic resins include poly(methyl methacrylate) and copolymers thereof. The acrylates include but are not limited to poly(methyl acrylate), poly(ethyl acrylate), and poly(butyl acrylate), and copolymers thereof.

A variety of styrenic resins are suitable for polymeric phases of the present invention. Such resins include vinyl aromatic polymers, such as syndiotactic polystyrene. Syndiotactic vinyl aromatic polymers useful in the present invention include poly(styrene), poly(alkyl styrene)s, poly (aryl styrene)s, poly(styrene halide)s, poly(alkoxy styrene)s, poly(vinyl ester benzoate), poly(vinyl naphthalene), poly(vinylstyrene), and poly(acenaphthalene), as well as the hydrogenated polymers and mixtures or copolymers containing these structural units. Examples of poly(alkyl styrene)s include the isomers of the following: poly(methyl styrene), poly(ethyl styrene), poly(propyl styrene), and poly(butyl styrene). Examples of poly(aryl styrene)s include the isomers of poly(phenyl styrene). As for the poly(styrene halide)s, examples include the isomers of the following: poly(chlorostyrene), poly(bromostyrene), and poly(fluorostyrene). Examples of poly(alkoxy styrene)s include the isomers of the following: poly(methoxy styrene) and poly(ethoxy styrene). Among these examples, the preferred styrene resin polymers, are: polystyrene, poly(p-methyl styrene), poly(m-methyl styrene), poly(p-tertiary butyl styrene), poly(p-chlorostyrene), poly(m-chloro styrene), poly(p-fluoro styrene), and copolymers of styrene and p-methyl styrene. The most preferred styrenic resins include polystyrene and copolymers thereof.

Particular polyester and copolyester resins are suitable for phases of the present invention. Such resins include poly(ethylene terephthalate) and copolymers thereof, poly(ethylene 2,6-naphthalenedicarboxylate) and copolymers thereof, poly(1,4-cyclohexandimethylene terephthalate) and copolymers thereof, and copolymers of poly(butylene terephthalate). The acid component of the resin can comprise terephthalic acid, isophthalic acid, 2,6-naphthalenedicarboxylic acid or a mixture of said acids. The polyesters and copolyesters can be modified by minor amounts of other acids or a mixture of acids (or equivalents esters) including, but not limited to, phthalic acid, 4,4′-stilbene dicarboxylic acid, 2,6-naphthalenedicarboxylic acid, oxalic acid, malonic acid, succinic acid, glutaric acid, adipic acid, pimelic acid, suberic acid, azelaic acid, sebacic acid, 1,12-dodecanedioic acid, dimethylmalonic acid, cis-1,4-cyclohexanedicarboxylic acid and trans-1,4-cyclohexanedicarboxylic acid. The glycol component of the resin can comprise ethylene glycol, 1,4-cyclohexanedimethanol, butylene glycol, or a mixture of said glycols. The copolyesters can also be modified by minor amounts of other glycols or a mixture of glycols including, but not limited to, 1,3-trimethylene glycol, 1,4-butanediol, 1,5-pentanediol, 1,6-hexanediol, 1,7-heptanediol, 1,8-octanediol, 1,9-nonanediol, 1,10-decanediol, 1,12-dodecanediol, neopentyl glycol, 2,2,4,4-tetramethyl-1,3-cyclobutanediol, diethylene glycol, bisphenol A and hydroquinone. The preferred polyester resins include copolyesters formed by the reaction of a mixture of terephthalic acid and isophthalic acid or their equivalent esters with a mixture of 1,4-cyclohexanedimethanol and ethylene glycol. The most preferred polyester resins include copolyesters formed by the reaction of terephthalic acid or its equivalent ester with a mixture of 1,4-cyclohexanedimethanol and ethylene glycol.

Certain polycarbonate and copolycarbonate resins are suitable for phases of the present invention. Polycarbonate resins are typically obtained by reacting a diphenol with a carbonate precursor by solution polymerization or melt polymerization. The diphenol is preferably 2,2-bis(4-hydroxyphenyl)propane (so-called “bisphenol A”) but other diphenols may be used as part or all of the diphenol. Examples of the other diphenol include 1,1-bis(4-hydroxyphenyl)ethane, 1,1-bis(4-hydroxyphenyl)cyclohexane, 2,2-bis(4-hydroxy-3,5-dimethylphenyl-)propane, 2,2-bis(4-hydroxy-3-methylphenyl)propane, bis(4-hydroxyphenyl)sulfideandbis(4-hydroxyphenyl)sulfone. The polycarbonate resin is preferably a resin which comprises bisphenol A in an amount of 50 mol % or more, particularly preferably 70 mol % or more of the total of all the diphenols. Examples of the carbonate precursor include phosgene, diphenyl carbonate, bischloroformates of the above diphenols, di-p-tolyl carbonate, phenyl-p-tolyl carbonate, di-p-chlorophenyl carbonate and dinaphthyl carbonate. Out of these, phosgene and diphenyl carbonate are particularly preferred.

A number of poly(alkylene) polymers are suitable for phases of the present invention. Such polyalkylene polymers include polyethylene, polypropylene, polybutylene, polyisobutylene, poly(4-methyl)pentene), copolymers thereof, chlorinated variations thereof, and fluorinated variations thereof.

Particular cellulosic resins are suitable for phases of the present invention. Such resins include cellulose acetate, cellulose acetate butyrate, cellulose acetate propionate, cellulose propionate, ethyl cellulose, cellulose nitrate. Cellulosic resins including a variety of plasticizers such as diethyl phthalate are also within the scope of the present invention.

Diffuser Plate Additives

Additives, components, blends, coatings, treatments, layers or regions may be combined on or within the aforementioned phases to provide additional properties. These may be inorganic or organic materials. They may be chosen to provide increased rigidity to enable support of additional films or backlight components. They may be chosen to provide increased thermal resistance so that the plate or film does not warp. They may be chosen to increase moisture resistance such that the plate does not warp or degrade other properties when exposed to high levels of humidity. These materials may be designed to provide improved optical performance by reducing wet-out when in contact with other components in the backlight. Additives may be used to absorb ultra-violet radiation to increase light resistance of the product. They may be chosen to increase, decrease, or match the scratch resistance of other components in the display or backlight system. They may be chosen to decrease the surface or volumetric resistance of the diffuser plate or film to achieve anti-static properties.

The additives may in components of one or more layers of the diffuser films or plates. They may be coatings that are added onto a surface or functional layers that are a combined during the manufacturing process. They may be dispersed throughout the volume of a layer or coating or they could be applied to a surface.

Adhesives such as pressure sensitive or UV cured adhesives may also be used between one or more layers to achieve optical coupling. Materials known to those in the field of optical plates, diffuser plates, films, backlights, to provide the optical, thermal, mechanical, environmental, electrical and other benefits may be used in the volume or on a surface, coating, or layer of the diffuser plate or film. The adhesive layer may also contain symmetric, asymmetric, or a combination of symmetric and asymmetric particles in order to achieve desired light scattering properties within the diffusion layer.

Anti-Static Additives

Anti-static monomers or inert additives may be added to one or more components of the diffuser plate or film components. Reactive and inert anti-static additives are well known and well enumerated in the literature. High temperature quaternary amines or conductive polymers may be used. As an anti-static agent, stearyl alcohol, behenyl alcohol, and other long-chain alkyl alcohols, glyceryl monostearate, pentaerythritol monostearate, and other fatty acid esters of polyhydric alcohols etc. may be used. In a preferred embodiment, stearyl alcohol and behenyl alcohol may be used.

Diffuser Plate Location

The diffuser plate may be located between the light-emitting sources and the display. In a preferred embodiment, the diffuser plate is located between a linear array of light sources and a film with collimating properties.

Diffuser Plate Size

The dimensions of the diffuser plate or films may extend to be substantially located between the light paths from the light sources to the display. In case of small displays, the diffuser plate may have a dimension in one direction of 1 cm or less, such as the case of a watch display. In larger displays, a dimension of the diffuser plate will, in general, be at least as large as one dimension of the final viewing screen. The thickness of the diffuser plate or films may be from 7 mm to less than 100 microns. In preferred embodiment, a diffuser plate contains an asymmetric diffusing film that is 200 microns in thickness optically coupled to a substrate that is approximately 1 mm in thickness. The capability of using a thin asymmetrically diffusing film to achieve sufficient diffusion for luminance uniformity allows for lower cost substrates to be used. Since the substrate can be substantially optically clear, low cost substrates may be used and they may have reduced weight, making lighter displays. The thin, asymmetrically diffusing layer also permits the capability of using a thinner substrate and therefore achieving a thinner diffuser plate and backlight.

Diffuser Plate Configuration

The diffuser plate may contain one or more diffusing layers that may symmetrically or asymmetrically diffuse incident light. The layers may be located on both or either surface of a plate or within the plate. In a preferred embodiment, an asymmetric diffusing layer is located beneath a substantially non-scattering transparent substrate. Three diffusing layers may also be used and they may be separated by substantially non-diffusing regions and the axis of one or more of the diffusing layers may be parallel, orthogonal or at an angle phi with respect to each other. The diffuser plate may contain additional layers or elements to provide collimating properties or other optical, thermal, mechanical, electrical, and environmental properties discussed herein. One or more layers of the diffuser plate may not be optically coupled to a substrate or other component of the diffuser plate. The combination of layers or materials is included herein under the description of diffuser plate with improved performance even though one or more layers may be substantially free-standing and not physically coupled.

Method of Manufacturing Diffuser Plate

In one embodiment of the present invention method for producing a light diffusing plate material contains the steps of selecting a first optically clear material and a second optically clear material, wherein the first and second optically clear materials have a refractive index difference of zero or greater than zero in at least one of the x, y, and z directions; are immiscible in one another; dispersing the second material in the first material, such as by vigorous mixing, melt mixing, compounding, mastication or a simple extrusion process of both materials; forming a film, sheet, or coating from the mixture, including hardening the film, and, where appropriate, orienting the material as an integral part of the sheet forming process to create asymmetrical optical properties. The selection of materials includes optically clear materials which are solid at room temperature and which, when heated, will become fluid at an elevated temperature such as thermoplastic polymeric materials. The invention further relates to sheet diffusers and diffuser plates made according to the processes disclosed herein.

Optical elements including plates, sheets, coatings, and films of a variety of thickness and structures may be manufactured using means such as film casting, sheet casting, profile extrusion, blown film extrusion, co-extrusion, injection molding, etc in accordance with embodiments of this invention. The material may be used as an individual diffuser film or plate or it may be combined with other materials or effects to provide an enhanced diffuser plate or film. The diffuser can be combined with other elements or contain features that improve the optical performance in terms of diffuse or specular transmission or reflection, gain, haze, clarity, backscatter, angular modification of the exiting light profile in one or more directions, percent of polarization preserved, and spectral transmission or absorption properties.

There are a number of different mechanisms for producing asymmetric diffusion profiles in the volume of the waveguide. These include creating asymmetric region by aligning particles through stretching a material or stretching a material to cause particles to become symmetric in shape. Other methods of alignment such as extrusion and other methods known in the industry can be used.

In another embodiment of this invention, a surface relief structure that asymmetrically scatters incident light is created on one or more surfaces of a diffuser plate through film casting, sheet casting, profile extrusion, blown film extrusion, co-extrusion, injection molding. In a preferred embodiment, the refractive index of the diffuser plate is substantially isotropic in one or more of the x, y, or z directions.

The diffuser plate could incorporate additional features or materials to provide additional optical qualities. Examples of features include embossing one or more surfaces of the substrate or diffuser with a regular, random, semi-random surface feature. This could be a diffractive, holographic, prismatic, microlens or other structure as described above. Additives could be used within the material to improve a number of performance requirements, including optical, mechanical, thermal, and environmental resistance.

Backlight Configuration

The enhanced backlight of this invention may contain one or more diffuser plates or films. The backlight may also contain other layers, coatings, or regions that collimate a portion of the light from the light sources in a direction toward the normal of the backlight. In one embodiment of this invention an enhanced diffuser plate (and backlight using the same), the light is directed at an angle theta with respect to the normal of the backlight and one or more of the optical films may direct a substantial amount of light toward this angle theta.

The backlight of this invention contains at least one asymmetrically diffusing layer located between the light source and the display. The light source may be one or more fluorescent sources, organic LED's, inorganic LED's, electroluminescent sources, carbon nanotube, FED, laser or other luminous sources known to be usable in display applications.

The shape and configuration of the light sources may be point sources such as discrete LED's, linear such as a linear array of CCFL lamps, grid arrays of LED's, serpentine shaped fluorescent bulbs, or a planar sources such as flat fluorescent lamps. The shape and configuration may be regular or irregular such that the resulting backlight system luminance is substantially uniform.

Collimating and Diffusing Films

One or more collimating films and diffuser films may be used within the backlight stack in order to achieve the desired luminance profile from the backlight and resulting display. In one preferred embodiment, a prismatic collimating film is used in the backlight to direct light from large angles in the vertical direction (as viewed in a typical television display application) toward the direction normal to the display. Two collimating films of linear arrays of prisms that are arranged perpendicular to each other (crossed prismatic films) may be used to further increase the amount of light directed perpendicular to the surface of the backlight or display. Diffusing films that contain surface features may provide collimating properties as well as diffusion properties. The diffusing properties may also help to reduce the visibility of features such as the tips of the prismatic arrays. In a preferred embodiment, a diffusion film is located between the diffuser plate and the prismatic collimating film. In another preferred embodiment, a diffuser film is located between the prismatic film and the display. In another embodiment, more than one diffuser film is located between the diffuser plate and the display and a prismatic film is not used.

Polarizers

Reflective polarizers are often used in backlight configurations to recycle the polarization that would normally be absorbed in the bottom polarizer of a liquid crystal display. Reflective polarizers may reflect linear or circularly polarized light. In a preferred embodiment a linear reflective polarizer is used between the collimating film and liquid crystal display. In another preferred embodiment, a reflective polarizer is used between the diffuser plate and the display.

The different variations in features and designs of the enhanced diffuser plate, backlight and method of manufacture described herein can be envisioned and include one or more combinations of the features described below:
1. Light sources: CCFL; LED; OLED; electroluminescent material; laser diode; carbon nanotube; fluorescent bulb; substantially planar fluorescent bulb; halogen bulb; incandescent bulb; metal halide bulb;
2. Light source color: Red; green; blue; white; cyan; magenta; yellow;
3. Light source location: in a plane substantially parallel to the display surface; beneath the display; one edge of the waveguide; more than one edge of a waveguide; opposite side of the waveguide than the liquid crystal cell; within the waveguide;
4. Light source configuration: linear array; grid array; regularly positioned; irregularly positioned; in red, green and blue clusters; color based arrays;
5. Spacing between light scattering regions, collimating films, display, polarizers, diffuser films, and diffusing plates: air gap; optically coupled.
6. Scattering region:
   a. Scattering region location: above the light source; beneath the display; above collimating film(s); below collimating film(s); in-between collimating films; within the collimating structures; in the substrate of the collimating structures; on the surface of the diffuser plate; within the volume of the diffuser plate; in regions of the substrate or collimating structures separated by a non-scattering region; within a polarizer; on the surface of a polarizer; within an adhesive layer;
   b. Diffusing particle shapes: symmetric particles; asymmetric particles; a combination of asymmetric and symmetric particles.
   c. Diffusing particles refractive index: average refractive index nₚ wherein |nₚ−nₘ|>0.001; refractive index nₚₓ and n_{py}, in the x and y directions respectively, wherein |nₚₓ−nₘ|>0.001; |n_{py}−nₘ|>0.001; or |n_{py}−nₘ|>0.001 and |nₚₓ−nₘ|>0.001; average refractive index nₚ wherein |nₚ−nₘ|<0.001; refractive index nₚₓ and n_{py}, in the x and y directions respectively, wherein |nₚₓ−nₘ|<0.001; |n_{py}−nₘ|<0.001; or |n_{py}−nₘ|<0.001 and |nₚₓ−nₘ|<0.001;
   d. Diffusing particles concentration: less than 1% by weight; greater than 1% and less than 40% by weight; between 40% and 50% by weight; greater than 50% by weight;
   e. Asymmetric particle alignment: substantially parallel to an edge of the display; substantially perpendicular to an edge of the display; or at an angle beta with respect to an edge of the display; substantially parallel to an array of light sources; substantially perpendicular to a an array of light sources or at an angle beta with respect to an array of light sources; substantially parallel to an array of collimating features; substantially perpendicular to a an array of collimating features or at an angle beta with respect to an array of collimating features.
7. Collimating feature type: Prismatic; microlens; pyramidal; conical; hemispherical; array of refractive features; array of diffractive features; array of light scattering features;
8. Collimating feature orientation: substantially parallel to an array of light sources; substantially perpendicular to a an array of light sources or at an angle beta with respect to an array of light sources; substantially parallel to an edge of the display; substantially perpendicular to an edge of the display; or at an angle beta with respect to an edge of the display;
9. Prismatic Collimating films:
   a. Prism Pitch: Constant; non-constant (irregular); random.
   b. Prism Orientation: At an angle, phi, with respect to a predetermined edge; or at an angle phi2, wherein phi2 varies across the length of the prisms.
   c. Prism height: Constant; varying lengthwise across the length of the prisms; varying from one prism to another.
   d. Prism Apex angle: At a constant angle, alpha; or at an angle alpha2, wherein alpha2 varies across the length of the prisms; or at an angle alpha3, wherein alpha3 can vary from one prismatic structure to the next
   e. Prism structure refractive index: nₘ, with the region in optical contact with the prism structure having a refractive index n₁ wherein nₘ>n₁.
   f. Surface structure on sheet face opposite prism face: planar; prismatic; microlens array; surface relief structure providing pre-determined angular scattering (included ruled structure, holographic diffuser); any combination of the above structures.
10. Polarizer type: Reflective; absorptive; linear; circular; partially reflective and absorptive;
11. Polarizer location: between the display and light source; between a collimating film and the diffuser plate; between a diffuser film and a collimating film; between the diffuser plate and a diffuser film;

Preferred embodiments of the present invention are illustrated in the following Example(s). The following examples are given for the purpose of illustrating the invention, but not for limiting the scope or spirit of the invention.

### EXAMPLE 1

The enhanced diffuser plate, in accordance with the present invention, shown in FIG. 4 contains an asymmetric diffusing layer optically coupled to a substantially transparent, non-diffusing substrate. The light diffusing layer contains asymmetric light scattering particles that are aligned such that they will be parallel to a linear array of CCFL's when the diffusing plate is used in a backlight. The asymmetric light scattering region contains asymmetric particles in a host matrix material. The regions may be created by creating a mixture consisting of polystyrene bead particles of diameter 5 um dispersed at concentrations up to 10% by volume in a host matrix of acrylic. Other choices of particles and host matrix may provide equivalent performance. The asymmetrically scattering diffuser plate can be created by co-extruding, casting or coating, the mixture containing the particles onto a transparent substrate polymer such as acrylic. The concentration of the light scattering particles can be chosen to provide the optimum backlight luminance uniformity. More details on techniques for creating asymmetric films or sheets can be found in U.S. Pat. No. 5,932,342 and Fusion Optix provisional patent applications entitled “ENHANCED LIGHT DIFFUSING SHEET,” “ENHANCED LCD BACKLIGHT,” and “ENHANCED LIGHT FIXTURE” and are incorporated in full as references herein. The resulting diffuser plate provides increased optical efficiency and control over the diffusion of light.

### EXAMPLE 2

An enhanced backlight, in accordance with the present invention, can be produced as described in FIG. 2, that is designed to have increased optical efficiency and therefore increased brightness relative to existing backlights. This is possible because the asymmetric diffusive layer between the linear array of light sources sufficiently diffuses only in the direction of perpendicular to the array light sources in order to obtain backlight luminance uniformity. The backlight consists of a linear array of light sources, a diffuser plate containing substantially aligned asymmetric particles, a diffusion sheet that provides collimation properties, a prismatic collimation film such as BEF from 3M to provide collimation in one direction, and a diffuse reflective polarizer such as Diffuse Reflective Polarizer Film (DRPF) from 3M to provide for polarization recycling, additional diffusion that reduces the visibility of the prismatic structures moiré, protects the prismatic structures from the rear polarizer of the display and reduces wet-out.

### EXAMPLE 3

An enhanced diffuser plate, in accordance with the present invention, is shown in FIG. 10. An asymmetrically diffusing layer is optically coupled to one side of a substrate and a surface relief profile of a linear array of prismatic structures is optically coupled to the opposite side of the substrate. The asymmetric light scattering region efficiently diffuses light from a linear array of light sources and the substrate provides a thickness through which the light may travel before being redirected through refraction and reflection on the surface of the prismatic film that is optically coupled to the opposite side of the substrate. The asymmetric diffuser layer is co-extruded onto a substantially transparent substrate. A radiation curable resin is coating on top of the substrate and a prismatic structure is embossed into a region of the coating with radiation curing the resin. The resulting diffuser plate provides increased optical efficiency and control over the diffusion of light.

### EQUIVALENTS

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. The contents of all references, issued patents, and published patent applications cited throughout this application are hereby incorporated by reference. The appropriate components, processes, and methods of those patents, applications and other documents may be selected for the invention and embodiments thereof.

What is claimed is:

1. An optical body with increased scattering efficiency including an input surface and an output surface and
a first region including a first concentration c₁ of first dispersed non-spherical domains with an average dimensional size, d_{1θ}, and average refractive index measured at a wavelength of 589 nanometers, n_{dlθ}, along a first axis, θ, and an average dimensional size d_{1φ} and average refractive index measured at a wavelength of 589 nanometers, n_{d1φ} along a second axis, φp, in a matrix material with refractive indexes n_{m1θ} and n_{m1φ} measured at a wavelength of 589 nanometers along the θ and φ axis, respectively,
$$such that \frac{{ⅆ}_{1 θ}}{{ⅆ}_{1 ϕ}} > 1.$$

2. The optical body of claim 1, further comprising a second region including a second concentration, c₂, of second dispersed non-spherical domains with an average dimensional size, d_{2α}, and average refractive index measured at 589 nanometers, n_{d2α}, along a third axis, α, and an average dimensional size, d_{2β}, and average refractive index measured at a wavelength of 589 nanometers, n_{d2β} along a fourth axis, β, in a matrix material with refractive indexes, n_{m2α} and n_{m2β}, measured at a wavelength of 589 nanometers along the α and β axis, respectively, wherein the second dispersed domains are non-spherical and
$$\frac{{ⅆ}_{2 α}}{{ⅆ}_{1 β}} > 1.$$

3. The optical body of claim 1, wherein the first concentration, c₁, varies spatially along the second axis, φ, when measured in a plane parallel to the output surface.

4. The optical body of claim 3, wherein the variation is substantially constant along the first axis, θ.

5. The optical body of claim 1, wherein the shapes of the first dispersed domains vary spatially along the second axis, φ, when measured in a plane parallel to the output surface.

6. The optical body of claim 3, wherein |n_{d1θ}−n_{m1θ}|<0.02.

7. The optical body of claim 6, wherein |n_{d1φ}−n_{m1φ}|>0.001.

8. The optical body of claim 3, wherein |n_{d1θ}−n_{m1θ}|<0.001.

9. The optical body of claim 4, wherein |n_{d1θ}−n_{m1θ}|<0.02.

10. The optical body of claim 9, wherein |n_{d1φ}−n_{m1φ}|>0.001.

11. The optical body of claim 4, wherein |n_{d1θ}−n_{m1θ}|<0.001.

12. The optical body of claim 2, wherein |θ−α|<10° and |φ−β|<10°.

13. The optical body of claim 2, wherein |θ−α|>80° and |φ−β|>80°.

14. The optical body of claim 2, wherein the far-field angular intensity profile cross sections, I_{θ}, I_{φ}, I_{ψ}, as measured with substantially collimated light at a wavelength of 550 nanometers along the multiple axis, θ, φ, and 45 degrees to theta, ψ, respectively, satisfy the equations I₀>I_{χ} and I_{φ}>I_{ψ}.

15. The optical body of claim 2, wherein the angle between the θ−φ plane and the α−β plane is greater than 80°.

16. The optical body of claim 15, wherein the light input surface is substantially perpendicular to the light output surface.

17. The optical body of claim 1, further comprising a light collimating surface relief feature on at least one surface.

18. The optical body of claim 17, wherein the collimating surface relief feature is selected from the group consisting of one or more of an array of: linear prism structures, micro-lens structures, or pyramidal structures; a lenticular lens array; and other surface topological features.

19. The optical body of claim 18, wherein the array of features are non-regular, semi-random, or random in at least one of size, shape, angle, radius, height, pitch, or orientation.

20. The optical body of claim 17, wherein the first region is separated by the second region by a substantially non-scattering region.

21. The optical body of claim 1, wherein |n_{d1θ}−n_{m1θ}|<0.02.

22. The optical body of claim 21, wherein |n_{d1φ}−n_{m1φ}>0.001.

23. The optical body of claim 1, wherein |n_{d1θ}−n_{m1θ}|<0.001.

24. The optical body of claim 2, wherein the mechanical stiffness of the optical body is increased relative to that of an optical body composed of similar materials without dispersed domains.

25. The optical body of claim 1, wherein the flexural modulus is 10% larger than that of an optical body composed of similar materials without dispersed domains.

26. The optical body of claim 1, wherein the flexural modulus is greater than 3 GigaPascals.

27. The optical body of claim 26, wherein at least one dispersed domain is a glass fiber.

28. A light-emitting device including an optical body of claim 25 and at least one light source.

29. The light-emitting device of claim 28, wherein the light-emitting device is included in an electroluminescent display.

30. A light-emitting device including an optical body comprising:
an input surface and an output surface and a first region including a first concentration, c₁, of first dispersed non-spherical domains with an average dimensional size, d_{1θ}, and average refractive index measured at a wavelength of 589 nanometers, n_{d1θ}, along a first axis, θ, and an average dimensional size d_{1φ} and average refractive index measured at a wavelength of 589 nanometers, n_{d1φ} along a second axis, φ, in a matrix material with refractive indexes, n_{m1θ} and n_{m1φ}, measured at a wavelength of 589 nanometers along the θ and φ axis, respectively,
$$wherein \frac{{ⅆ}_{1 θ}}{{ⅆ}_{1 ϕ}} > 1 ; and$$
an array of light-emitting sources with a pitch, p_{α} and p_{β} in the α and β axis, respectively, that substantially equal the pitch of the local concentration maximums, p_{cα} and p_{cβ} in the α and β axis, respectively.

31. The light-emitting device of claim 30, further comprising a second region including a second concentration, c₂, of second dispersed non-spherical domains with an average dimensional size, d_{2α}, and average refractive index measured at 589 nanometers, n_{d2α}, along a third axis, α, and an average dimensional size, d_{2β}, and average refractive index measured at a wavelength of 589 nanometers, n_{d2β} along a fourth axis, β, in a matrix material with refractive indexes, n_{m2α} and n_{m2β}, measured at a wavelength of 589 nanometers along the α and β axis, respectively, wherein
$$\frac{{ⅆ}_{2 α}}{{ⅆ}_{1 β}} > 1.$$

32. The light-emitting device of claim 31, wherein the light-emitting device is included in an electroluminescent display.

33. The light-emitting device of claim 30, wherein
$$0.8 \leq \frac{{p}_{α}}{{p}_{c α}} \leq 1.2 and 0.8 \leq \frac{{p}_{β}}{{p}_{c β}} \leq 1.2 .$$

34. A light-emitting device including the optical body comprising an input surface and an output surface and a first region including a first concentration, c₁, of first dispersed non-spherical domains with an average dimensional size, d_{1θ}, and average refractive index measured at a wavelength of 589 nanometers, n_{d1θ}, along a first axis, θ, and an average dimensional size, d_{1φ}, and average refractive index measured at a wavelength of 589 nanometers, n_{d1φ}, along a second axis, φ, in a matrix material with refractive indexes, n_{m1θ} and n_{m1φ}, measured at a wavelength of 589 nanometers along the θ and φ axis, respectively,
$$such that \frac{{ⅆ}_{1 θ}}{{ⅆ}_{1 ϕ}} > 1 ; and$$
an array of light-emitting sources with a pitch p_{θ} and p_{φ} in the θ and φ axis, respectively, that substantially equal the pitch of the localized dimensional size maximums p_{sθ} and p_{sφ} in the θ and φ axis, respectively.

35. The light-emitting device of claim 34, wherein the light-emitting device is included in an electroluminescent display.

36. The light-emitting device of claim 34, wherein
$$0.8 \leq \frac{{p}_{θ}}{{p}_{s θ}} \leq 1.2 and 0.8 \leq \frac{{p}_{φ}}{{p}_{s φ}} \leq 1.2 .$$

37. A light-emitting device comprising:
a first light-emitting source,
a second light-emitting source,
a light-transmissive region comprising a first light-transmissive material of refractive index n₁ₓ, n_{1y}, n_{1z} when measured with light of a wavelength of 589 nanometers along the x, y, and z axis, respectively, a first light-receiving surface disposed to receive light from the first light-emitting source, a first light re-directing region disposed to receive light from the first light-receiving surface, and a second light-receiving surface that is substantially planar and disposed to receive light from the second light-emitting source, wherein the second light-receiving surface is oriented at an angle σ from the first light-receiving surface,
a substantially planar light-emitting surface oriented substantially parallel to the second light-receiving surface that is disposed to receive light re-directed from the first light re-directing region and the light transmitted through the second light-receiving surface.

38. The light-emitting device of claim 37, wherein a portion of the light from the first light-emitting source totally internal reflects on at least one air-material interface within the light-transmissive region.

39. The light-emitting device of claim 37, further comprising at least one brightness-enhancement film selected from the group consisting of a prismatic collimating film including a linear array of surface prisms, a reflective polarizer, a light diffusing film, and a light collimating film including dispersed beads in a coating.

40. The light-emitting device of claim 38, wherein 80°≦σ≦90°.

41. The light-emitting device of claim 38, wherein 0°≦σ≦10°

42. The light-emitting device of claim 38, wherein the first light-emitting source is a linear array of light-emitting diodes and the second light-emitting source is an array of linear fluorescent lamps.

43. The light-emitting device of claim 38, wherein the first light re-directing region contains at least two light scattering domains of a second light-transmissive material of refractive index n₂ₓ, n_{2y}, n_{2z} when measured with light of a wavelength of 589 nanometers.

44. The light-emitting device of claim 43, wherein the first light re-directing region is a spatially varying array of regions including beads dispersed in a binder.

45. The light-emitting device of claim 43, wherein the light scattering domains are non-spherical in shape.

46. The light-emitting device of claim 45, wherein the first light re-directing region anisotropically re-directs the light received from the first light-emitting source and from the second light-emitting source.

47. The light-emitting device of claim 46, further comprising a second light re-directing region that receives the light from the first light-emitting source and from the second light-emitting source.

48. The light-emitting device of claim 46, wherein the first light re-directing region includes a spatially varying concentration of light scattering domains.

49. The light-emitting device of claim 43, wherein the shape of the light-scattering domains varies spatially.

50. The light-emitting device of claim 48, wherein the refractive index difference between the first and second light-transmitting materials is at least one selected from a group consisting of |n₁ₓ−n₂ₓ|<0.02, |n_{1y}−n_{2y}|<0.02, and |n_{1z}−n_{2z}|<0.02.

51. The light-emitting device of claim 48, wherein the light-transmitting region comprises a non-scattering lightguide and the light re-directing region is an anisotropic diffuser optically coupled to the lightguide.

52. The light-emitting device of claim 48, wherein the light-transmitting region comprises an anisotropically scattering lightguide.

53. The light-emitting device of claim 38, wherein the first light re-directing region is selected from a group consisting of: a surface relief feature that reflects light; a surface relief feature that refracts light; a surface relief feature that reflects and refracts light.

54. The light-emitting device of claim 38, wherein the light-emitting device is included with a spatial light modulator in an electroluminescent display.

55. The light-emitting device of claim 54, wherein the spatial light modulator is a liquid crystal panel and the display is a liquid crystal display.

56. The light-emitting device of claim 54, wherein the display is operating in at least one of the following modes: field sequential color, dynamic spatial color enhancement, dynamic spatial luminance enhancement, dynamic contrast enhancement, dark-room center contrast greater than 300:1, color gamut larger than 90% NTSC, luminance greater than 300 Cd/m², and multiple source color spectrum modes.
